(19) United States
(12) Patent Application Publication
(10) Pub. No.: US 2018/0120864 A1
(43) Pub. Date: May 3, 2018

(54) NONLINEAR CONTROL OF MASS FLOW CONTROLLER DEVICES USING SLIDING MODE

(71) Applicant: Illinois Tool Works Inc., Glenview, IL (US)

(72) Inventors: Ahmed H. EL-SHAER, Glenview, IL (US); Jeffrey L. WHITELEY, Glenview, IL (US)

(21) Appl. No.: 15/563,910

(22) PCT Filed: Mar. 8, 2016
(86) PCT No.: PCT/US2016/021327

§ 371 Date: Oct. 2, 2017

Related U.S. Application Data
(60) Provisional application No. 62/158,115, filed on May 7, 2015.

(51) Int. Cl. G05D 7/06; G05B 17/02

(52) U.S. Cl. CPC G05D 7/0623; G05B 17/02; G05D 7/0635

(57) ABSTRACT

The disclosed embodiments include a mass flow controller that implements a systematic sliding mode control algorithm that achieves robust and consistent flow-rate set-point tracking. Advantages of the disclosed embodiments include, but not limited to, rapid prototyping of easy-to-maintain embedded firmware and ease-of-tuning of controller parameters, which significantly reduces complexity of controller tuning. Other embodiments, advantages, and novel features are set forth in the detailed description.

### CROSS-REFERENCE TO RELATED APPLICATION

This application claims priority to U.S. Provisional Patent Application Ser. No. 62/158,115, filed May 7, 2015 entitled NONLINEAR CONTROL OF MASS FLOW CONTROLLER DEVICES USING SLIDING MODE, the entire teachings of which are incorporated herein.

### BACKGROUND

A mass flow controller (MFC) is a device used to measure and control the flow of liquids and gases. Generally, a MFC is designed and calibrated to control a specific type of liquid or gas at a particular range of flow rates. The MFC can be given a setpoint from 0 to 100% of its full scale range but is typically operated in the 10 to 90% of full scale where the best accuracy is achieved. The device will then control the rate of flow to the given setpoint. MFCs can be either analog or digital. A digital flow controller is usually able to control more than one type of fluid whereas an analog controller is limited to the fluid for which it was calibrated.

MFCs are used pervasively in the semi-conductor manufacturing to implement product-specific recipes involving different gases required at desired flow-rate set-points. Thus, MFC performance is crucial for overall process yield maximization.

### SUMMARY OF THE INVENTION

The disclosed embodiments include a mass flow controller that implements a systematic sliding mode control algorithm that achieves robust and consistent flow-rate set-point tracking. Advantages of the disclosed embodiments include, but not limited to, rapid prototyping of easy-to-maintain embedded firmware and ease-of-tuning of controller parameters, which significantly reduces complexity of controller tuning.

One disclosed embodiment is a method of implementing a closed loop sliding mode control for a mass flow controller that includes the implementation of a model that represents the indicated flow rate dynamics as function of key system parameters; defining a flow tracking error; defining a sliding surface function; estimating a rate of change of the flow tracking error; and deriving a control input function. In various embodiments, estimating the rate of change of the flow tracking error includes at least one of determining the rate of change of the valve position, accounting for the effect of inlet pressure transients, and accounting for the effect of outlet pressure transients for pressure-based mass flow controllers that have outlet pressure. In various embodiments, the control input function includes two main tuning parameters λ, and η, wherein η is a parameter chosen to speed the rate of convergence of the sliding surface to zero, and λ is a bandwidth parameter of the sliding surface function which determines a rate of tracking performance.

Another disclosed embodiment is a mass flow controller for controlling a flow of a fluid, the mass flow controller including an inlet for receiving the fluid; a flow path in which the fluid passes through the mass flow controller; a mass flow meter for providing a signal corresponding to mass flow of the fluid through the flow path; a control valve for regulating the flow of the fluid out of an outlet of the mass flow controller; and a controller configured to execute a closed loop sliding mode control algorithm to apply a valve control signal to adjust the control valve to a desired valve position to control the flow of the fluid out of an outlet of the mass flow controller.

Additional embodiments, advantages, and novel features are set forth in the detailed description.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an example of a mass flow controller in which embodiments of a closed loop sliding mode control (SMC) for flow rate set-point tracking may be utilized in accordance the disclosed embodiments;

FIG. 2 is a block diagram of a MFC valve-unit control system in accordance with the disclosed embodiments;

FIG. 3 is a flowchart illustrating a process for implementing a sliding mode control algorithm for a mass flow controller system in accordance with the disclosed embodiments; and

FIGS. 4 through 6 are graphs illustrating sample results of closed loop flow response in accordance with the disclosed embodiments.

The illustrated figures are only exemplary and are not intended to assert or imply any limitation with regard to the environment, architecture, design, or process in which different embodiments may be implemented.

### DETAILED DESCRIPTION OF THE DRAWINGS

The invention and the various features and advantageous details thereof are explained more fully with reference to the nonlimiting embodiments that are illustrated in the accompanying drawings and detailed in the following description. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, descriptions of well-known materials, processing techniques, components, and equipment are omitted so as not to unnecessarily obscure the invention in detail. It should be understood, however, that the detailed description and the specific examples, while indicating particular embodiments of the invention, are given by way of illustration only and not by way of limitation. Further, the illustrated figures are only exemplary and are not intended to assert or imply any limitation with regard to the environment, architecture, design, or process in which different embodiments may be implemented. Various substitutions, modifications, additions, and/or rearrangements within the spirit and/or scope of the underlying inventive concept will become apparent to those skilled in the art from this disclosure.

Other features and advantages of the disclosed embodiments will be or will become apparent to one of ordinary skill in the art upon examination of the following figures and detailed description. It is intended that all such additional features and advantages be included within the scope of the disclosed embodiments.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity. In addition, as used herein, the singular forms “a”, “an” and “the” are intended to include the plural forms as well, unless the context clearly indicates otherwise.

Additionally, the term “fluid” is used herein to describe any type of matter in any state capable of flow. The term “gas” is used herein to describe any fluid for which density is substantially dependent on absolute pressure, such as ideal or non-ideal gases, vapors, and supercritical fluids. The term “liquid” is used herein to describe any fluid for which density is not substantially dependent on absolute pressure.

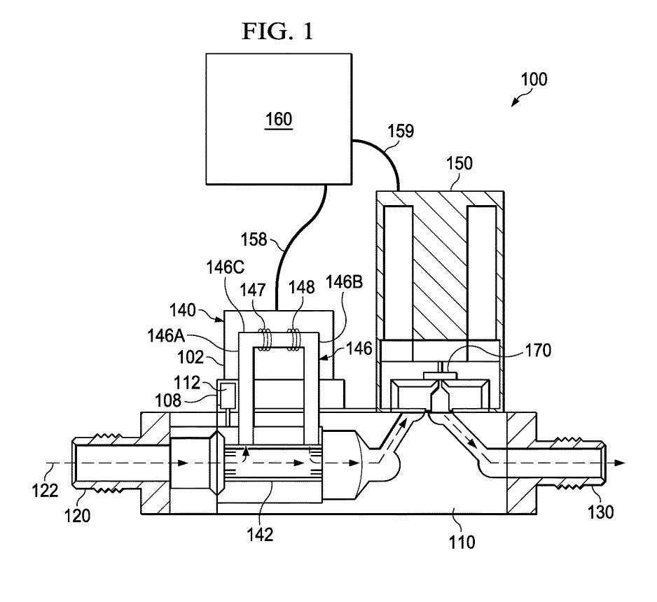

Beginning with FIG. 1, an example of a mass flow controller 100 is presented in which embodiments of a closed loop sliding mode control (SMC) for flow rate set-point tracking may be utilized in accordance the disclosed embodiments. The mass flow controller 100 includes a block 110, which is the platform on which the components of the MFC are mounted. A thermal mass flow meter 140 and a valve assembly 150 containing a valve 170 are mounted on the block 110 between a fluid inlet 120 and a fluid outlet 130. When in use, a fluid source (not depicted) is coupled to the fluid inlet 120 of the mass flow controller 100 and some process (e.g., semi-conductor manufacturing process) is coupled to the fluid outlet 130 of the mass flow controller 100.

The thermal mass flow meter 140 includes a bypass 142 through which typically a majority of fluid flows and a thermal flow sensor 146 through which a smaller portion of the fluid flows. The bypass 142 is tuned with the known fluid to determine an appropriate relationship between fluid flowing in the mass flow sensor and the fluid flowing in the bypass 142 at various known flow rates, so that the total flow through the flow meter can be determined from the sensor output signal. The mass flow sensor portion and bypass 142 may then be mated to the control valve 170 and control electronics 160 and then tuned again, under known conditions. The responses of the control electronics 160 and the control valve 170 are then characterized so that the overall response of the system to a change in set point or input pressure is known, and the response can be used to control the system to provide the desired response.

Thermal flow sensor 146 is contained within a sensor housing 102 (portion shown removed to show sensor 146) mounted on a mounting plate or base 108. Sensor 146 is a small 25 diameter tube, typically referred to as a capillary tube, with a sensor inlet portion 146A, a sensor outlet portion 146B, and a sensor measuring portion 146C about which two resistive coils or windings 147, 148 are disposed. In operation, electrical current is provided to the two resistive windings 147, 148, which are in thermal contact with the sensor measuring portion 146C. The current in the resistive windings 147, 148 heats the fluid flowing in measuring 30 portion 146 to a temperature above that of the fluid flowing through the bypass 142. The resistance of windings 147, 148 varies with temperature. As fluid flows through the sensor conduit, heat is carried from the upstream resistor 147 toward the downstream resistor 148, with the temperature difference being proportional to the mass flow rate through the sensor.

An electrical signal related to the fluid flow through the sensor is derived from the two resistive windings 147, 148. The electrical signal may be derived in a number of different ways, such as from the difference in the resistance of the resistive windings or from a difference in the amount of energy provided to each resistive winding to maintain each winding at a particular temperature. Examples of various ways in which an electrical signal correlating to the flow rate of a fluid in a thermal mass flow meter may be determined are described, for example, in commonly owned U.S. Pat. No. 6,845,659, which is hereby incorporated by reference. The electrical signals derived from the resistive windings 14 7, 148 after signal processing comprise a sensor output signal.

The sensor output signal is correlated to mass flow in the mass flow meter so that the fluid flow can be determined when the electrical signal is measured. The sensor output signal is typically first correlated to the flow in sensor 146, which is then correlated to the mass flow in the bypass 142, so that the total flow through the flow meter can be determined and the control valve 170 can be controlled accordingly. The correlation between the sensor output signal and the fluid flow is complex and depends on a number of operating conditions including fluid species, flow rate, inlet and/or outlet pressure, temperature, etc.

The process of correlating raw sensor output to fluid flow entails tuning and/or calibrating the mass flow controller and is an expensive, labor intensive procedure, often requiring one or more skilled operators and specialized equipment. For example, the mass flow sensor may be tuned by running known amounts of a known fluid through the sensor portion and adjusting certain signal processing parameters to provide a response that accurately represents fluid flow. For example, the output may be normalized, so that a specified voltage range, such as 0 V to 5 V of the sensor output, corresponds to a flow rate range from zero to the top of the range for the sensor. The output may also be linearized, so that a change in the sensor output corresponds linearly to a change in flow rate. For example, doubling of the fluid output will cause a doubling of the electrical output if the output is linearized. The dynamic response of the sensor is determined, that is, inaccurate effects of change in pressure or flow rate that occur when the flow or pressure changes are determined so that such effects can be compensated.

When the type of fluid used by an end-user differs from that used in tuning and/or calibration, or when the operating conditions, such as inlet and outlet pressure, temperature, range of flow rates, etc., used by the end-user differ from that used in tuning and/or calibration, the operation of the mass flow controller is generally degraded. For this reason, the flow meter can be tuned or calibrated using additional fluids (termed “surrogate fluids”) and or operating conditions, with any changes necessary to provide a satisfactory response being stored in a lookup table. U.S. Pat. No. 7,272,512 by Wang et al., entitled “Flow Sensor Signal Conversion,” which is owned by the assignee of the present invention and which is hereby incorporated by reference, describes a system in which the characteristics of different gases are used to adjust the response, rather than requiring a surrogate fluid to calibrate the device for each different process fluid used.

In addition, the mass flow controller 100 may include a pressure transducer 112 coupled to the flow path at some point, typically, but not limited to, upstream of the bypass 142 to measure pressure in the flow path. Pressure transducer 112 provides a pressure signal indicative of the pressure. In accordance with the disclosed embodiments, the pressure transducer 112 is used to measure pressure during a rate of decay measurement.

Control electronics 160 control the position of the control valve 170 in accordance with a set point indicating the desired mass flow rate, and an electrical flow signal from the mass flow sensor indicative of the actual mass flow rate of the fluid flowing in the sensor conduit. Traditional feedback control methods such as proportional control, integral control, proportional-integral (PI) control, derivative control, proportional-derivative (PD) control, integral-derivative (ID) control, and proportional-integral-derivative (PID) control are then used to control the flow of fluid in the mass flow controller. A control valve drive signal is generated based upon an error signal that is the difference between a set point signal indicative of the desired mass flow rate of the fluid and a feedback signal that is related to the actual mass flow rate sensed by the mass flow sensor. The control valve is positioned in the main fluid flow path (typically downstream of the bypass and mass flow sensor) and can be controlled (e.g., opened or closed) to vary the mass flow rate of fluid flowing through the main fluid flow path, the control being provided by the mass flow controller.

In the illustrated example, the flow rate is supplied by electrical conductors 158 to a closed loop system controller 160 as a voltage signal. The signal is amplified, processed and supplied to the control valve assembly 150 to modify the flow. To this end, the controller 160 compares the signal from the mass flow sensor 140 to predetermined values and adjusts the proportional valve 170 accordingly to achieve the desired flow.

In accordance with the disclosed embodiments, the mass flow controller 100 may be configured to utilize a closed loop sliding mode control (SMC) for flow rate set-point tracking. Although, the mass flow controller 100 is depicted with a thermal flow meter, the disclosed embodiments may operate using any type of flow meter including, but not limited to, thermal flow meters, pressure-based flow meters, and Coriolis flow meters. As described above, thermal flow meters uses thermal-based transducers which correlate the rate of heat transfer, or temperature differential, along the heated by-pass sensor tube to gas flow rate. In contrast, pressure-based flow meters uses pressure-based transducers in which the flow rate can be expressed as function of pressure drop across a laminar flow element.

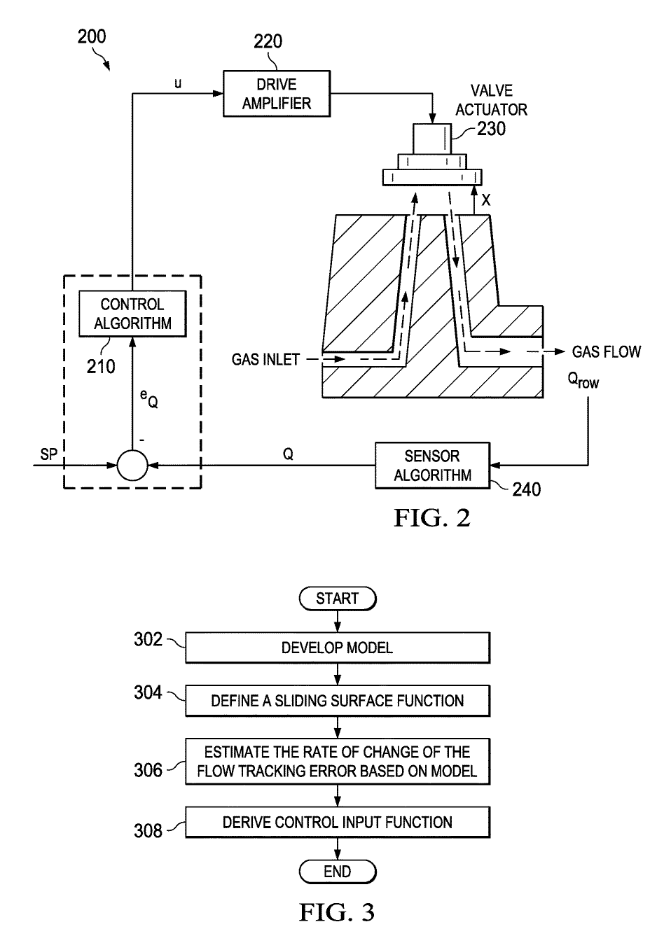

FIG. 2 is a block diagram illustrating the signal-flow of a MFC valve-unit control system 200 in accordance with the disclosed embodiments. In the depicted embodiment, Q_{raw} denotes the raw flow signal, usually in volts, generated by the flow transducer as discussed above; Q is the indicated flow signal usually expressed in m³/sec, or standard cubic centimeters per minute (sccm); SP is the desired flow rate set-point; e_{Q}=SP−Q is the tracking error; and u is the control signal produced by the control algorithm.

As indicated in FIG. 2, the MFC valve-unit control system 200 receives the desired flow rate set-point SP. The MFC device operates normally at a number of inlet pressures Pᵢₙ varying from a minimum to a maximum value decided by a given process. The set-point SP also ranges from a minimum to a maximum value and is set by the user. The set-point is commonly normalized in percentage of the full scale (FS) (i.e. the maximum rated) flow-rate of a given device. For example, SP=50% FS indicates a set-point at 50% of the maximum rated flow rate.

Based on the SP, the MFC valve-unit control system 200 executes a control algorithm 210 to generate the control signal u. The control signal u is then amplified by a valve drive amplifier 220 to excite a valve actuator/mechanical assembly 230 causing a valve lift displacement x.

The MFC valve-unit control system 200 then executes a sensor algorithm 240 using the raw flow signal generated by the flow transducer Q_{raw} to determine the indicated flow signal Q. The MFC valve-unit control system 200 then subtracts the indicated flow signal Q from the SP to determine the tracking error e_{Q}.

An important performance criterion of an MFC control system is to make the tracking error e_{Q} equal zero for a given SP; that is, Q(t)=SP(t) in a reasonably short period of time, commonly referred to as the settling time. However, due to presence of noise in measuring Q(t), this criterion can be expressed as |Q(t)−SP(t)|≤ε, where ε is a small positive number which reflects the desired steady-state tracking accuracy that needs to be achieved sufficiently fast with minimal overshoot in the transient response; i.e. well-damped closed loop response.

Accordingly, the disclosed embodiments provide various embodiments of a mass flow controller that implements a systematic sliding mode control algorithm that achieves robust and consistent flow-rate set-point tracking. For example, in some embodiments, the mass flow controller is configured to use model-based nonlinear control theoretic that suits the application at hand, leading to systematic closed loop performance robustness.

As an example, FIG. 3 is a flowchart illustrating a process 300 for implementing a sliding mode control (SMC) algorithm for a mass flow controller system in accordance with a disclosed embodiment. In the depicted embodiment, the process 300 for implementing a sliding model control begins at step 302 by developing a model or analytic expression for the indicated flow rate dynamics as function of key system parameters. In other words, the model provides an indication as to how flow is affected by the system variables. For instance, in one embodiment, one such model can be expressed by the following equation:

Q(t)=F(Pᵢₙ,x,Pₒᵤₜ,μ,Temp)(t), Eq. 1

where:
1) Q(t) is the indicated flow from the MFC device [m³/sec or sccm],
2) F (.,.,.,.,.)(t) is a time-varying flow function model [m³/sec or sccm],
3) Pᵢₙ: flow inlet pressure [Pa],
4) x: valve displacement position [m],
5) Pₒᵤₜ: flow outlet pressure [Pa],
6) μ: gas viscosity [Pa·sec],
7) Temp: gas temperature [C or K],

The expression given in Eq. 1 is nonlinear in its arguments. The gas viscosity and other properties are readily available in databases dedicated to gas properties. Other suitable nonlimiting example of models that may be used in accordance with the disclosed embodiments are described in U.S. Pat. No. 6,962,164, by Lull et al., entitled “System and method for a mass flow controller,” which is owned by the assignee of the present invention and which is hereby incorporated by reference.

At step 304, the process defines a sliding surface function. The sliding surface function provides a means to define the desired accuracy of the tracking error as the performance objective of the proposed control system. As described above in reference to FIG. 2, the flow tracking error between the desired set-point and the sensed flow rate is defined as:

e_{Q}(t):=SP(t)−Q(t). Eq. 2

where SP(t) represents a given flow-rate set-point, and Q(t) is the indicated flow signal.

For a given dynamical system, it is noted that there could be many alternatives to define a sliding surface expression as a function of the controlled system dynamics to achieve desired control objective. For example, one embodiment of a sliding surface function in accordance with the disclosed embodiments is provided below in Eq. 3. As shown in the below expression, the sliding surface equals the weighted sum of flow tracking error and the integral of the tracking error weighted by an error bandwidth parameter.

$$σ ( t ) = ( \frac{d}{dt} + λ ) {\int }_{0}^{t} {e}_{Q} ( τ ) d τ = {e}_{Q} ( t ) + λ {\int }_{0}^{t} {e}_{Q} ( τ ) d τ \qquad Eq . 3$$

where λ>0 is the bandwidth parameter of the sliding surface which determines the rate of tracking performance.

Based on the above sliding surface function, as σ(t)→0, then e_{Q}(t)→0 (i.e., the tracking error is driven to zero). The notation σ(t)→0 implies in the limit as t→∞; that is, lim_{t→∞}σ(t)=0. Thus, asymptotic set-point tracking is achieved. In one embodiment, this is accomplished using the following equation:

\dot{σ}(t)=ė_{Q}(t)+e_{Q}(t). Eq. 4

In accordance with one embodiment, using Eq. 1, the process, at step 306, then estimates the rate of change of e_{Q}(t) as shown in Eq. 5 based on the model. In one embodiment, the process assumes that Pₒᵤₜ, μ, and Temp in Eq. 1 are relatively slowly varying.

$${\dot{e}}_{Q} ( t ) := \dot{SP} ( t ) - ( \frac{\partial F}{\partial x} \dot{x} ( t ) + \frac{\partial F}{\partial {P}_{i n}} {\dot{P}}_{i n} ( t ) ) , \qquad Eq . 5$$

where \dot{x}(t) is the rate of change of the valve position (i.e. the velocity of the valve lift). The valve position x is available either via measurement or calculation. The term

$$\frac{\partial F}{\partial {P}_{i n}} {\dot{P}}_{i n} ( t )$$

in Eq. 5 represents the effect of inlet pressure transients/disturbances.

In certain embodiments, for pressure-based MFCs that have outlet pressure Pₒᵤₜ available for measurement, an additional term

$$\frac{\partial F}{\partial {P}_{out}} {\dot{P}}_{out} ( t )$$

can be added to Eq. 5 to account for variations in Pₒᵤₜ.

At step 308, the process then derives the control input function. For example, in FIG. 2, the control input u is interpreted as a reference command to the valve position. Hence, the valve drive amplifier's main function is to regulate the valve position x(t) to its desired value u(t). In one embodiment, this function can be represented by the transfer function

$$\frac{x}{u} = \frac{b}{s + a} \qquad Eq . 6$$

where s is the Laplace operator, b and a are the valve drive servo-loop gain and bandwidth, respectively.

The transfer function in Eq. 6 describes the desired nominal behavior of the servo loop of the valve actuator. In certain embodiments, the servo loop parameters in Eq. 6 are available either via input-output experimental data-based modeling, or adaptively calculated. Other relevant expressions for this, including higher order dynamics, can be readily implemented in the disclosed embodiments. From the above, the below expression for the control input u(t) is obtained:

$$u ( t ) = \frac{1}{b} ( ax ( t ) + \frac{1}{( \frac{\partial F}{\partial x} )} ( \dot{SP} ( t ) + λ {e}_{Q} ( t ) + η σ ( t ) ) + \frac{\partial F}{\partial {P}_{i n}} {\dot{P}}_{i n} ( t ) + K sign ( σ ) ) \qquad Eq . 7$$

In the above Eq. 7, η>0 is a parameter chosen to speed the rate of convergence of the sliding surface to zero. The term K sign(σ) is used to introduce robustness to the closed loop tracking performance, thus forcing the convergence condition “σ(t)=0” to happen in a reasonably short time despite the presence of plant parameter variations and exogenous disturbances.

The above disclosed embodiments describe a systematic sliding mode control algorithm that is simple, stable, and easy to implement and maintain. For instance, in accordance with the disclosed embodiments, the SMC controller only uses two tuning parameters: λ, η.

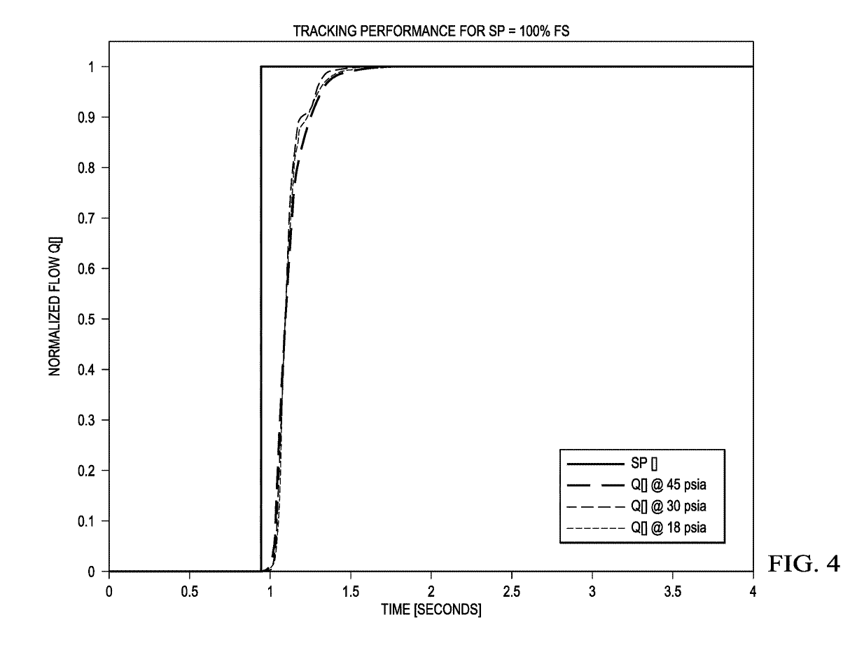

FIGS. 4 through 6 are graphs illustrating sample results of closed loop flow response in accordance with the disclosed embodiments. The sample plots were generated using Nitrogen (N₂) as the working gas. The plots illustrate the flow tracking performance for the normalized set-points:

1) SP=100% FS (illustrated in FIG. 4)

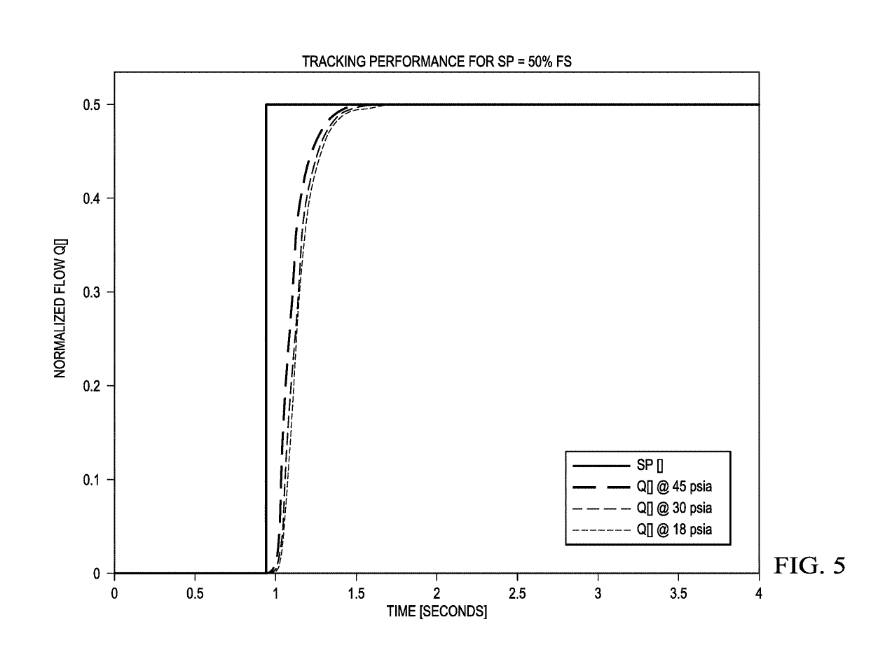

2) SP=50% FS (illustrated in FIG. 5)

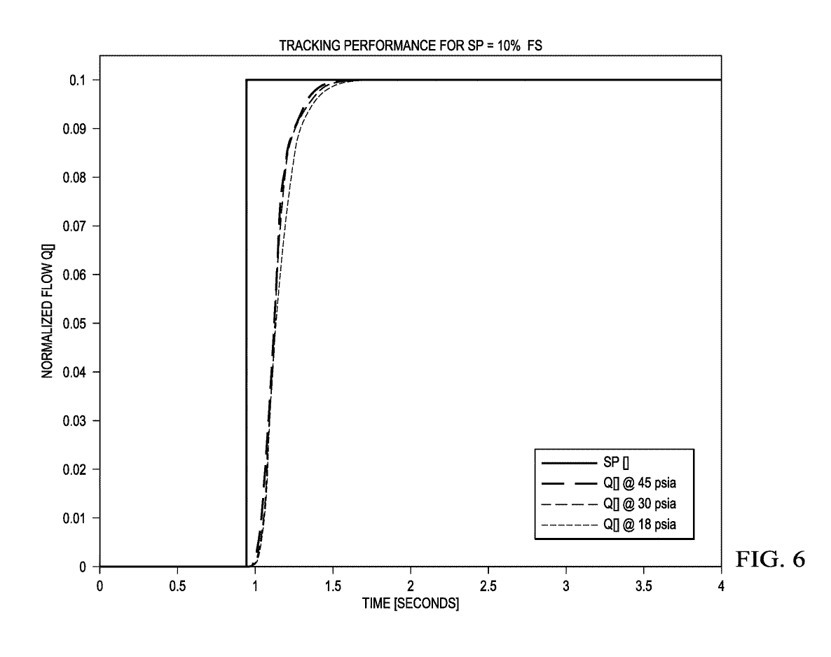

3) SP=10% FS (illustrated in FIG. 6)

For each set-point, the following inlet pressures values are applied Pᵢₙ=45, 30 and 18 psia.

Based on the sample results, for the choice of λ=40, η=25, it is clear that the closed loop tracking performance is consistently well damped and achieves steady-state tracking at approximately 0.5 seconds for the different set-points and inlet pressures considered.

Accordingly, the above description enables a method of implementing a closed loop sliding mode control for a mass flow controller. Advantages of the disclosed embodiments include, but not limited to, 1) guaranteed robust performance of closed loop flow-rate set-point tracking; 2) rapid prototyping of easy-to-maintain embedded firmware; 3) ease-of-tuning of controller parameters (essentially only λ, η) which significantly reduces complexity of controller tuning, enhances production efficiency and minimizes product development cycle; and 4) the controller framework is applicable to different mass flow-rate controller technologies which include thermal and pressure-based flow sensing, as well as wide range different valve flow regulation applications.

Extensive review of existing technical literature on control systems of micro-fluidic devices indicates that the approach presented here is the first model-based advanced control design for MFCs which utilizes tools from non-linear control theory to systematically achieve required flow tracking closed loop performance. Unlike the more widely used PID-type controllers which are inherently non-model based type controllers and require extensive gas-dependent parameter tuning and look-up tables, the disclosed SMC implementation is comprehensive and integrates fluid flow dynamics, valve-drive feedback servo and nonlinear control theory elegantly to achieve accurate, gas-independent flow-rate tracking performance.

As previously stated, the above description including the diagrams are intended merely as examples of the disclosed embodiments and is not intended to limit the structure, process, or implementation of the disclosed embodiments. As understood by one of ordinary skill in this art that certain aspects of the disclosed embodiments described herein may be implemented as firmware, firmware/software combination, firmware/hardware combination, or a hardware/firmware/software combination.

It is further understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

We claim:

1. A method of implementing a closed loop sliding mode control for a mass flow controller, the method comprising:
implementing a model for the indicated flow rate dynamics as function of key system parameters;
defining a flow tracking error;
defining a sliding surface function;
estimating a rate of change of the flow tracking error; and
deriving a control input function.

2. The method of claim 1, wherein estimating the rate of change of the flow tracking error includes determining the rate of change of the valve position.

3. The method of claim 1, wherein estimating the rate of change of the flow tracking error includes accounting for the effect of inlet pressure transients.

4. The method of claim 1, wherein estimating the rate of change of the flow tracking error includes accounting for the effect of outlet pressure transients for pressure-based mass flow controllers that have outlet pressure.

5. The method of claim 1, wherein the control input function includes two main tuning parameters λ, and η.

6. The method of claim 5, wherein η is a parameter chosen to speed the rate of convergence of the sliding surface to zero.

7. The method of claim 5, wherein λ is a bandwidth parameter of the sliding surface function which determines a rate of tracking performance.

8. The method of claim 1, wherein the model for the indicated flow rate dynamics is expressed as: Q(t)=F(Pᵢₙ, x, Pₒᵤₜ, μ, Temp)(t),
where:
Q(t) is the indicated flow from the MFC device [m³/sec or sccm],
F (.,.,.,.,.)(t) is a time-varying flow function model [m³/sec or sccm],
Pᵢₙ: flow inlet pressure [Pa],
x: valve displacement position [m],
Pₒᵤₜ: flow outlet pressure [Pa],
μ: gas viscosity [Pa·sec], and
Temp: gas temperature [C or K].

9. The method of claim 1, wherein the flow tracking error is expressed as e_{Q}(t):=SP(t)−Q(t).

10. The method of claim 1, wherein the sliding surface function is expressed as
$$σ ( t ) = ( \frac{d}{dt} + λ ) {\int }_{0}^{t} {e}_{Q} ( τ ) d τ = {e}_{Q} ( t ) + λ {\int }_{0}^{t} {e}_{Q} ( τ ) d τ ,$$
where λ>0 is the bandwidth parameter of the sliding surface which determines the rate of tracking performance.

11. The method of claim 1, wherein estimating the rate of change of the flow tracking error is expressed as
$${\dot{e}}_{Q} ( t ) := \dot{SP} ( t ) - ( \frac{\partial F}{\partial x} \dot{x} ( t ) + \frac{\partial F}{\partial {P}_{i n}} {\dot{P}}_{i n} ( t ) ) ,$$
where \dot{x}(t) is the rate of change of the valve position and
$$\frac{\partial F}{\partial {P}_{i n}} {\dot{P}}_{i n} ( t )$$
represents me effect of inlet pressure transients.

12. The method of claim 1, wherein the control input function is expressed as
$$u ( t ) = \frac{1}{b} ( ax ( t ) + \frac{1}{( \frac{\partial F}{\partial x} )} ( \dot{SP} ( t ) + λ {e}_{Q} ( t ) + η σ ( t ) ) + \frac{\partial F}{\partial {P}_{i n}} {\dot{P}}_{i n} ( t ) + K sign ( σ ) ) ,$$
where η>0 is a parameter chosen to speed the rate of convergence of the sliding surface to zero.

13. The method of claim 2, wherein the valve position is obtain via measurement.

14. The method of claim 2, wherein the valve position is obtain via calculation.

15. A mass flow controller for controlling a flow of a fluid, the mass flow controller comprising:
an inlet for receiving the fluid;
a flow path in which the fluid passes through the mass flow controller; a mass flow meter for providing a signal corresponding to mass flow of the fluid through the flow path;
a control valve for regulating the flow of the fluid out of an outlet of the mass flow controller; and
a controller configured to execute a closed loop sliding mode control algorithm to apply a valve control signal to adjust the control valve to a desired valve position to control the flow of the fluid out of an outlet of the mass flow controller.

16. The mass flow controller of claim 15, wherein the closed loop sliding mode control algorithm comprises:
implementing a model that indicates flow rate dynamics as function of key system parameters;
defining a flow tracking error;
defining a sliding surface function;
estimating a rate of change of the flow tracking error; and
deriving a control input function

17. The mass flow controller of claim 16, wherein estimating the rate of change of the flow tracking error includes determining the rate of change of the valve position.

18. The mass flow controller of claim 16, wherein estimating the rate of change of the flow tracking error includes accounting for the effect of inlet pressure transients.

19. The mass flow controller of claim 16, wherein estimating the rate of change of the flow tracking error includes accounting for the effect of outlet pressure transients for pressure-based mass flow controllers that have outlet pressure.

20. The mass flow controller of claim 16, wherein the sliding surface function is expressed as
$$σ ( t ) = ( \frac{d}{dt} + λ ) {\int }_{0}^{t} {e}_{Q} ( τ ) d τ = {e}_{Q} ( t ) + λ {\int }_{0}^{t} {e}_{Q} ( τ ) d τ ,$$
where λ>0 is the bandwidth parameter of the sliding surface which determines the rate of tracking performance.
